(19) United States
(12) Patent Application Publication
(10) Pub. No.: US 2016/0363371 A1
(43) Pub. Date: Dec. 15, 2016

(54) TOTAL -WEIGHT DETECTION-BASED METHOD AND SYSTEM THEREOF FOR ON-LINE MEASURING AND CONTROLLING MOISTURE IN CIRCULATION DRYING OF GRAIN

(71) Applicant: Changchun JIDA Scientific Instruments Equipment CO. LTD, Changchun (CN)

(72) Inventors: Wenfu Wu, Changchun (CN); Feng Han, Changchun (CN); Yaqiu Zhang, Changchun (CN); Zhe Liu, Changchun (CN); Hongfei Gao, Changchun (CN); Xinyi Wu, Changchun (CN)

(73) Assignee: Changchun JIDA Scientific Instruments Equipment CO. LTD

(21) Appl. No.: 15/180,091

(22) Filed: Jun. 13, 2016

Related U.S. Application Data
(63) Continuation of application No. PCT/CN2013/090905, filed on Dec. 30, 2013.

(30) Foreign Application Priority Data
Dec. 13, 2013 (CN) 201310682597.8
Dec. 13, 2013 (CN) 201320823116.6

(51) Int. Cl. F26B 25/22; F26B 23/02; F26B 25/00; G01N 5/04; F26B 17/18

(52) U.S. Cl. CPC F26B 25/225; G01N 5/045; F26B 17/18; F26B 25/001; F26B 23/02; F26B 2200/06

(57) ABSTRACT

A total weight detection-based method and system thereof for on-line measuring and controlling a moisture in circulation drying of grain. In the method, by detecting a real-time weight of the grain in a drying machine and calculating a real-time average moisture of the grain, process control on circulation drying operation is implemented. The method comprises the following steps: initialization of operation, detection of a tare weight, loading of grain and measurement of an initial total weight W₀, starting of circulation drying operation, monitoring of a circulation drying process, control of the circulation drying process, and the like. A total weight detection-based system for on-line measuring and controlling a moisture in circulation drying of grain according the method comprises a drying machine main body (1), an induced draft fan (3), a grain feeding/discharge elevator (5), and a weighing sensor group (6), wherein the weighing sensor group (6) is arranged below the drying machine main body (1), and used for detecting an initial total weight W₀ of the drying machine loaded with the grain to be dried, a tare weight W_{b}, and a real-time total weight Wᵢ. The system can accurately measure a weight in a case in which the working of a drying agent is not stopped, and is applicable to circulation drying of crops such as corn, rice and wheat.

### CROSS-REFERENCE TO RELATED APPLICATIONS

This application is a continuation of International Patent Application No. PCT/CN2013/090905 with an international filing date of Dec. 30, 2013 designating the United States, now pending and further claims priority benefits to Chinese Patent Application No. 201310682597.8 filed Dec. 13 2013, and Chinese Patent Application No. 201320823116.6, filed Dec. 13 2013. The content of the aforementioned applications, including any intervening amendments thereto, is incorporated herein by reference.

### TECHNICAL FIELD

The present invention relates to a method for on-line measuring and controlling a moisture in a grain drying machine, and particularly relates to a total weight monitoring-based method for on-line measuring and controlling a moisture, which is suitable for a circulation-type grain drying machine. The present invention further relates to a total weight detection-based system for on-line measuring and controlling a moisture in circulation drying of grain according the method.

### BACKGROUND

A method for on-line controlling a moisture in grain drying is essential for the work of grain drying, and the existing on-line measurement and control for a moisture in grain drying is carried out on the basis of capacitance-method on-line moisture measurement and control or resistance-method on-line moisture measurement and control, and by means of switch control, classical PID control or modern intelligent predictive control. On-line moisture measurement and control is critical for moisture control during a drying process.

The principle of the resistance-method on-line moisture measurement and control is that a moisture of grain is indirectly measured by virtue of the correlation relationship between the moisture of the grain and the resistance value thereof, and the resistance value is low in case of high moisture, and is high in case of low moisture. In a circulation-type grain drying machine, a resistance-type moisture sensor is generally used for on-line detection, and is generally installed on the sidewall of a barrel of an elevator of the drying machine; grain particles scattering from a lifting bucket of the elevator constantly fall into a pair of oppositely-rotating rollers separately; and the rollers are a pair of electrodes. The grain particles are crushed while passing through the rollers, and resistance change curves of materials between the roller electrodes are measured; the characteristic values of the resistance change curves of a certain number of grain particles are extracted and subjected to rolling statistics, so as to evaluate the average value of the characteristic values; the moisture value of the grain is evaluated according to the (pre-calibrated) relationship between the average value and a moisture correlation function; and finally target control or process control is implemented on a grain drying process according to the moisture value. An on-line moisture detector with the principle is used in KANEKO, SUNCUE (Taiwan), SATAKE and other well-known drying machine companies; and Changyou Li of South China Agriculture University developed the on-line moisture detector with the principle, and patented the invention (with an authorized announcement number of CN1963478A, and an application number of 200610123461.3). The resistance-method on-line moisture detection has the following shortcomings: \textcircled{1} when grain has a non-uniform moisture, and contains many green and immature particles, a high error of the monitored value is caused; \textcircled{2} the structure is complex, and the failure rate is high; \textcircled{3} when stones and other foreign matters are contained in the materials, damages to rollers due to blockages at rollers are easily caused; \textcircled{4} the resistance-method on-line moisture detection is only adaptive to grains with similar characters and particle sizes, for example, rice and wheat, and if the type of the grain is changed, a sensor needs to be greatly changed; \textcircled{5} the resistance-method on-line moisture detection is destructive detection; and \textcircled{6} detection accuracy for a moisture in high-moisture grain is low.

The principle of the capacitance-method on-line moisture measurement and control is that a moisture of grain is indirectly measured by virtue of the correlation relationship between the moisture of the grain and a capacitance, and the capacitance is high in case of high moisture, and is low in case of low moisture. At present, a capacitance-type moisture sensor is used in a circulation-type automatic grain drying machine, and the capacitance-type moisture sensor is generally a barrel-shaped object with a certain capacity, and is installed in a tempering section of the circulation-type grain drying machine, or in an outlet grain flow; and the grain flows through capacitance plates, and the change of a moisture content is measured according to different dielectric properties due to different moistures of the grain. Detection for the moisture is realized, and then control for grain drying is adjusted through a secondary instrument or an upper computer according to the moisture value of the grain. The on-line moisture detector in this form is produced by Changchun Jida Scientific Instrument Equipment Co., Ltd, Shanghai Oasis Company and other domestic enterprises. The on-line moisture detector has the following shortcomings: \textcircled{1} installation and maintenance are inconvenient; \textcircled{2} detection accuracy is greatly influenced by the temperature and humidity of environment, the temperature and humidity of grain, the density of the grain, and the flow speed of the grain, and thus is low; and \textcircled{3} a monitoring error is large in case of high impurity content of the grain.

Chinese Patent with a publication number of CN103438693A discloses a drying machine weighing by virtue of a weighing sensor; however, the weighing sensor is internally installed, running of a fan, a heater and other components must be stopped during each weighing, and the working efficiency of the drying machine is seriously influenced due to no continuous running. The technical solution cannot effectively solve the influence of vibrations of the components of the drying machine on weighing, and the lives of these components will be also shortened due to frequent switch-on and switch-off for the fan, the heater and other components; and the requirement of product industrialization cannot be achieved as well.

### SUMMARY

The objective of the present invention is to overcome shortcomings in the prior art and methods, and provide a total weight detection-based method for on-line measuring and controlling a moisture in a grain circulation drying machine; and another objective of the present invention is to provide a total weight detection-based system for on-line measuring and controlling a moisture in circulation drying of grain.

The method for on-line controlling a moisture in circulation drying of grain, which is provided by the present invention, is deducing the changes of a total mass and a moisture of the grain, and change trends during a drying process, on the basis of the detection carried out by a total weight sensor group of the drying machine, for the mass of the contained grain, and the mass of the overall device of the drying machine, and with reference to detection for the temperature and humidity of a heat medium, and the temperature of the grain during drying operation, and carrying out constant-temperature control or constant-speed control on the drying process.

Initialization of operation: an initial moisture value M₀ of grain to be dried, a target moisture value M_{T}, a temperature (not greater than 140° C.) of a heat medium, and an upper limit of a moisture dropping speed (the moisture dropping speed V is not greater than 2.5%) are input to and stored in a control display unit of a drying machine; and a drying operation manner (constant-temperature drying manner or constant-speed drying manner) is selected.

Detection of a tare weight: an electrical signal is detected by virtue of a weighing sensor group installed on the lower part of the drying machine in a state of no grain in the drying machine, the weighing sensor group is connected with a signal detection and conversion unit, the signal detection and conversion unit is used for converting the electrical signal to a weight signal, and the signal detection and conversion unit is connected with the control display unit; and the tare weight W_{b} is detected, read and stored by the control display unit.

Loading of grain and measurement of an initial total weight W₀: a grain feeding device of the drying machine is started, high-moisture grain to be dried is conveyed into the drying machine, a material level sensor is installed in the drying machine, the height of the grain is controlled by the material level sensor during a conveying process, and the grain feeding device continues conveying if a set height is not achieved, and stops conveying after the set height is achieved. Then the initial total weight W₀ is detected, read and stored through the control and display unit.

Starting of circulation drying operation: the grain in the drying machine circularly runs, and a combustor is started simultaneously to allow the needed heat medium to dry the grain.

Monitoring of a circulation drying process: a real-time total weight W, is continuously detected, read and stored through the control and display unit, and a real-time moisture value Mᵢ (an average moisture value at time i) of the grain to be dried is finally displayed by carrying out internal operation according to the following formula.

$${M}_{i} = \frac{( {W}_{0} - {W}_{b} ) {M}_{0} - ( {W}_{0} - {W}_{i} )}{{W}_{i} - {W}_{b}}$$

Wherein, W₀ is the initial total weight of the grain to be dried and loaded in the drying machine, W_{b} is the tare weight, Wᵢ is the total weight at time i during the drying process, and M₀ is the initial moisture;

and a moisture dropping amplitude of a unit time, that is, a moisture dropping speed V, is evaluated by dividing the difference between the moisture values obtained through two times of calculations with a certain time interval by a time interval length.

$$V = \frac{Δ M}{Δ t}$$

Wherein, ΔM is the difference between the moisture values obtained through calculations with a certain time interval, and Δl is the time interval length.

Control of the circulation drying process: there are two circulation drying manners for selection. When the constant-temperature control manner is selected, the temperature of the provided heat medium is kept at a set temperature, and the set temperature is generally within an appropriate up-and-down fluctuation range of 50° C. to 120° C. (the temperature of the heat medium is not greater than ±20° C. of the set temperature); and when a speed-limiting control manner is selected, the temperature of the heat medium is adjusted to control a real-time moisture dropping speed to be less than a set value.

When the real-time moisture value Mᵢ of the grain has not yet entered the appropriate fluctuation value range (for example, ±0.5%) surrounding the target moisture value, the flow returns to the monitoring of the circulation drying process; when the real-time moisture value Mᵢ of the grain enters the appropriate fluctuation value range (for example, ±0.5%) surrounding the target moisture value, supply of the heat medium is stopped; and then the grain in the drying machine is completely discharged, and one batch of the circulation drying operation is concluded.

The constant-temperature control is judging whether the moisture of the grain achieves a safe moisture specified by national standards or not, the safe moisture value is 14%, the drying operation is stopped (the focus is to stop the supply of the heat medium) and the grain discharge operation is started if the safe moisture is achieved, or else, drying is continued.

The constant-speed control belongs to switch quantity control, logical judgment and model predictive analysis are carried out on the basis of the total weight or the moisture of the grain, the temperature of the grain, the temperature and humidity of the heat medium, and the temperature and humidity of environment, and the temperature of the heat medium, and a grain discharge speed are controlled, so that the moisture dropping speed of the grain is kept at or lower than a certain value (for example, the moisture dropping speed of rice is kept at 0.8%, and the moisture dropping speed of corn is lower than 2.5%) until the safe moisture is achieved. A classical PID method or a predictive control method (combining model prediction for a moisture change with PID control) is adopted in control strategies of the constant-speed control and the speed-limiting control.

The total weight detection-based system for on-line measuring and controlling a moisture in circulation drying of grain, which is provided by the method of the present invention, mainly comprises a drying machine main body, a grain feeding/discharge elevator, a combustor, an induced draft fan, an air duct, a weighing sensor group, a signal detection and conversion unit, and a control display unit, wherein the weighing sensor group is arranged below the drying machine main body, the weighing sensor group is connected with the signal detection and conversion unit, and the signal detection and conversion unit is connected with the control display unit. In the overall device of the drying machine, the grain feeding/discharge elevator may be a bucket-type elevator for completing grain feeding and grain discharge in a time-sharing manner through a flow direction switchover device, or two bucket-type elevators may also be used for completing grain feeding and grain discharge respectively in a time-sharing manner.

The drying machine main body comprises an upper auger, a tempering part, a drying part, a lower body and a loading hopper; the upper auger plays a role of conveying grain in the grain feeding/discharge elevator to the tempering part; the tempering part is arranged below the upper auger, the drying part is arranged below the tempering part, and the lower body is arranged below the drying part; the lower body is a main body part of the overall device of the drying machine; the lower body comprises a grain discharge mechanism and a lower auger, and plays a role of re-conveying the grain in the lower body into the grain feeding/discharge elevator, so as to complete one drying circulation. The grain to be dried re-enters the grain feeding/discharge elevator through the loading hopper after one drying circulation is completed, and enters the next circulation drying process.

The weighing sensor group is composed of a plurality of weighing sensors installed on the base of the drying machine main body, and used for realizing detection of the weight change of the grain loaded in the drying machine; a temperature and humidity sensor group comprises detection sensors for the temperature and humidity of the environment, the temperature of the grain, the temperature of the heat medium, and the like; the signal detection and conversion unit is used for amplifying the detected total weight, temperature and humidity, and other signals, converting the signals to digital signals, and transmitting the digital signals to a control unit (an upper computer); and the control unit is mainly used for receiving the signals of the related signals of the system, judging and analyzing the signals, and then implementing on-line moisture control on the drying machine. Through reasonable arrangements of the weighing sensors, running of any component of the drying machine has no need to be stopped in a continuous working state of the drying machine, and various weight parameters can be accurately measured, thus accurate control for a drying effect is realized.

Two connection manners are adopted for connection of the weighing sensor group and the overall device of the drying machine:

1) semi-supporting structure: the weighing sensor group is installed under supporting feet of the base of the drying machine, the weight of the drying machine main body containing the grain falls onto the sensors, the grain feeding/discharge elevator is connected with the drying machine main body in a hinge manner, and a hot-blast stove and the induced draft fan are connected with the drying machine main body through air tube flexible connectors; in this way, influence of the connections, vibrations and masses of the elevator, the hot-blast stove and the induced draft fan on the detection carried out by the weighing sensors is avoided; and

2) full-supporting structure: the weighing sensor group is mutually connected with the drying machine through a connection bottom plate, the drying machine main body and the grain feeding/discharge elevator are installed above the connection bottom plate, and the hot-blast stove and the induced draft fan are still connected with the drying machine main body through air tube flexible connectors.

Further preferably, the weighing sensor group of the drying machine is composed of a plurality of weighing sensors, and arranged below supporting feet of a lower body of the drying machine main body or below the connection bottom plate.

Further preferably, each annular isolation pad is arranged above the corresponding spoke elastomer, each whole sensor is of a spoke-type structure, and the centre part of each weighing sensor is machined into a hub. An annular groove is machined in the outer side of each spoke along a circumferential direction, eight small through holes are uniformly distributed and machined in each annular groove, and resistance strain gauges are distributed in each small through hole.

### Beneficial Effects:

1. According to the present invention, the change of the moisture of the grain during the drying process is detected through detection for the total weight of the drying machine and the grain in the drying machine, on-line control for the moisture of the grain is realized, and the traditional resistance method and capacitance method are replaced. The temperature and humidity sensitivity of the resistance method and the capacitance method is overcome; the accuracy and stability of the on-line moisture detection are improved; and a measurement area of the on-line moisture detection is expanded. The detection accuracies of the resistance method and the capacitance method in a low-moisture area (with a moisture of 13%-18%) of the grain barely achieve ±0.5%, and the stabilities thereof are about 80%; whereas the detection accuracy of the weighing method in a full-moisture area (with a moisture of 13%-35%) can easily achieve ±0.5%, and the stability thereof is 80%.

2. According to the present invention, in order to avoid the influence of the connections, masses and the like of the accessory devices on the detection, by virtue of the characteristics of the structure and the operation of the grain circulation drying machine, the weighing sensor group, the drying machine main body and the accessory components are connected in the hinge manner and through the flexible connectors, or the accessory devices are all arranged above the weighing sensor group. The working efficiency of the drying machine is improved, the drying machine is enabled to continuously work, and the influence of the vibrations of the components of the drying machine on weighing is effectively solved.

3. According to the present invention, since the accuracy in the full area of the moisture detection is greater than ±0.5%, it can be ensured that target control, speed-limiting control and constant-speed control are implemented on the drying process through the provided system and method, thus the automation degree of the drying machine is increased, and energy-saving drying and quality-guaranteeing drying can be realized; therefore, improvement for the technological levels of automation and intelligentization of drying facilities in China is promoted, and the technological levels can surpass those of countries with advanced technologies, such as Japan and Canada.

4. The system for on-line controlling a moisture in circulation drying of grain, which is provided by the present invention, has the advantages of being simple in structure, convenient to install, simple to operate, high in anti-interference capacity, high in environmental adaptability, and the like, is applicable to circulation drying operation of crops such as corn, rice and wheat, and avoids the major shortcomings of the prior art.

### DESCRIPTION OF THE DRAWINGS

FIG. 1 is a schematic diagram of the method of the present invention.

FIG. 2 is a structural block diagram of the system of the present invention.

FIG. 3 is a structural schematic diagram of the drying machine of the first embodiment of the present invention.

FIG. 4 is structural schematic diagrams of the drying machine main body and the grain feeding/discharge elevator shown in FIG. 3 of the present invention.

FIG. 5 is a structural schematic diagram of the hinge connection manner of the drying machine main body and the elevator at part A in FIG. 3 of the present invention.

FIG. 6 is a plan structural schematic diagram of each weighing sensor of the present invention.

FIG. 7 is a part sectioned view of each weighing sensor of the present invention.

FIG. 8 is a flow diagram of bridge circuit connection of the weighing sensors, signal detection and conversion, and control and display of the present invention.

FIG. 9 is an outline drawing of the control display unit of the present invention.

FIG. 10 is a control block diagram of the mode I of the method of the present invention.

FIG. 11 is a schematic diagram of the moisture change curve of the mode I of the method of the present invention.

FIG. 12 is a control block diagram of the mode II of the method of the present invention.

FIG. 13 is a schematic diagram of the moisture change curve of the mode II of the method of the present invention.

FIG. 14 is a structural schematic diagram of the drying machine of the second embodiment of the present invention.

FIG. 15 is a structural schematic diagram of the drying machine of the third embodiment of the present invention.

FIG. 16 is a structural schematic diagram of the drying machine of the fourth embodiment of the present invention.

### EMBODIMENTS

The method for on-line measuring and controlling a moisture in a grain drying machine of the present invention is further illustrated with reference to specific embodiments. Take rice to be dried, and with a weight of 8 tons and an initial moisture of 26% for example.

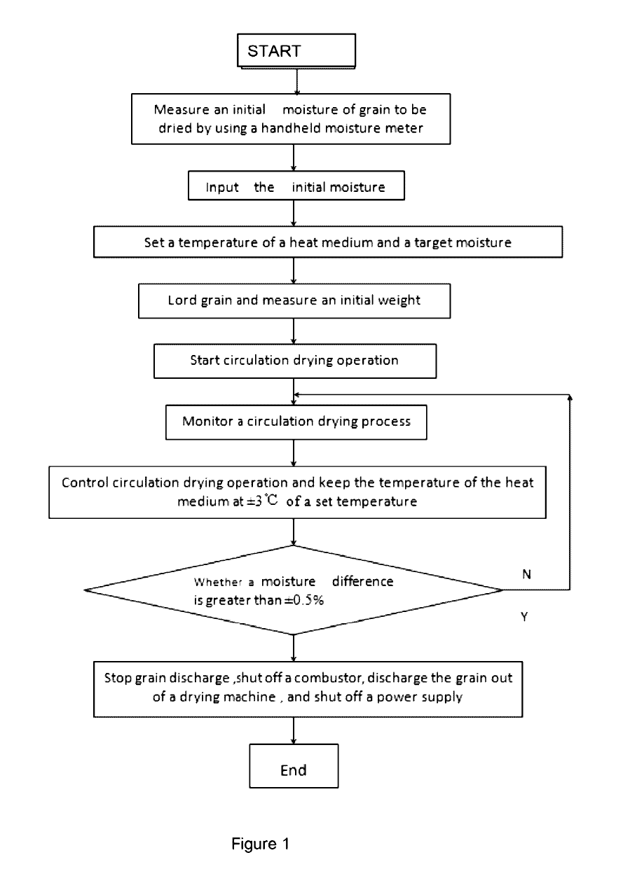

As shown in FIG. 1, the method for on-line measuring and controlling a moisture in a grain drying machine of the present invention comprises the following steps:

Initialization of operation: an initial moisture value M₀=26% of rice to be dried, a target moisture value M_{T}=14%, a temperature of 50° C. of a heat medium, and an upper limit of a moisture dropping speed (preferably, the moisture dropping speed V is not greater than 2.5%) are input to and stored in a control display unit of a drying machine; and a drying operation manner (constant-temperature drying manner or constant-speed drying manner) is selected.

Detection of a tare weight: an electrical signal is detected by virtue of a weighing sensor group installed on the lower part of the drying machine in a state of no grain in the drying machine, the weighing sensor group is connected with a signal detection and conversion unit, the signal detection and conversion unit is used for converting the electrical signal to a weight signal, and the signal detection and conversion unit is connected with the control display unit; and the tare weight is detected, read and stored by the control display unit, and the detected tare weight is 1.8 tons.

Loading of grain and measurement of an initial total weight W₀: a grain feeding device of the drying machine is started, high-moisture rice to be dried is conveyed into the drying machine, a material level sensor is installed in the drying machine, the height of the grain is controlled by the material level sensor during a conveying process, and the grain feeding device continues conveying if a set height is not achieved, and stops conveying after the set height is achieved. Then the initial total weight W₀ is detected, read and stored through the control and display unit to be 9.8 tons.

Starting of circulation drying operation: an upper auger, an elevator, a lower auger, a grain discharge mechanism and a combustor are sequentially started to start the circulation drying operation, the grain in the drying machine is circulated, and meanwhile, the combustor circularly dries for the needed heat medium to dry, and the temperature of the heat medium is 50° C.

Monitoring of a circulation drying process: a real-time total weight Wᵢ is continuously detected, read and stored through the control and display unit, and a real-time moisture value Mᵢ (an average moisture value at time i) of the grain to be dried is finally displayed by carrying out internal operation according to the following formula.

$${M}_{i} = \frac{( {W}_{0} - {W}_{b} ) {M}_{0} - ( {W}_{0} - {W}_{i} )}{{W}_{i} - {W}_{b}}$$

Wherein, W₀ is the initial total weight in drying, W_{b} is the mass (tare weight) of the drying machine main body, Wᵢ is the total weight at time i during the drying process, M₀ is the initial moisture, and Mᵢ is the average moisture of the grain in the drying machine at time i during the drying process;

and a moisture dropping amplitude of a unit time, that is, a moisture dropping speed V, is evaluated by dividing the difference between the moisture values obtained through two times of calculations with a certain time interval by a time interval length.

$$V = \frac{Δ M}{Δ t}$$

Wherein, ΔM is the difference between the moisture values obtained through calculations with a certain time interval, and Δl is the time interval length.

Control of the circulation drying process: there are two circulation drying manners for selection. When the constant-temperature control manner is selected, the temperature of the provided heat medium is kept at a set temperature, and kept in a range of ±3° C.; preferably, the set temperature is 50° C.; and when a speed-limiting control manner is selected, the temperature of the heat medium is adjusted to control a real-time moisture dropping speed to be less than a set value of 2.5%.

When the real-time moisture value Mᵢ of the grain has not yet entered the appropriate fluctuation value range (for example, ±0.5%) surrounding the target moisture value of 14%, the flow returns to the monitoring of the circulation drying process; when the real-time moisture value Mᵢ of the grain enters the appropriate fluctuation value range (for example, ±0.5%) surrounding the target moisture value of 14%, supply of the heat medium is stopped; and then the grain in the drying machine is completely discharged, and one batch of the circulation drying operation is concluded.

### The First Embodiment

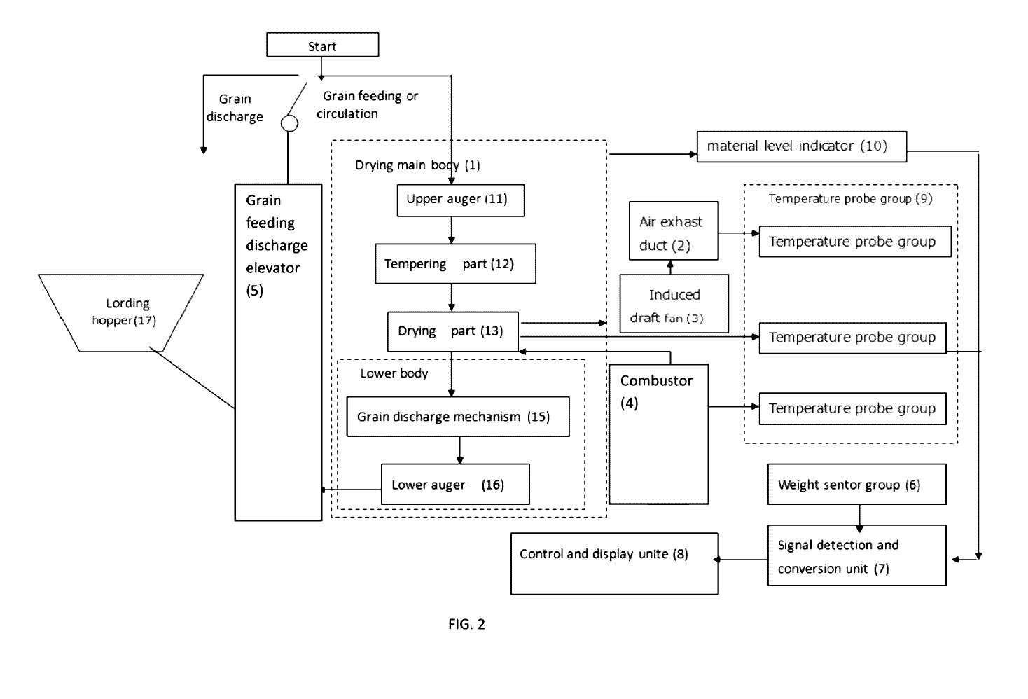

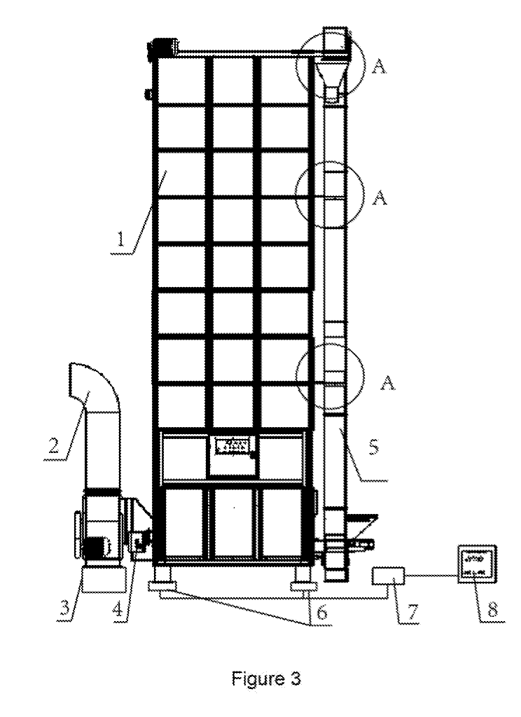

FIG. 2 and FIG. 3 are a case of a total weight detection-based system for on-line measuring and controlling a moisture in circulation drying of grain according the method of the present invention, but the present invention is not limited to the case. The system comprises a drying machine main body 1, an air exhaust duct 2, an induced draft fan 3, a combustor 4, a grain feeding/discharge elevator 5, a weighing sensor group 6, a signal detection and conversion unit 7, a control display unit 8, a temperature and humidity probe group 9, and a material level indicator 10. During operation, grain to be dried is loaded in the drying machine main body 1, the weighing sensor group 6 of the drying machine is distributed below the drying machine main body 1, the weighing sensor group 6 is connected together with the signal detection and conversion unit 7, and the signal detection and conversion unit 7 is connected with the control display unit 8. The drying machine main body 1, the air exhaust duct 2, the induced draft fan 3, the combustor 4, the grain feeding/discharge elevator 5, the weighing sensor group 6, the signal detection and conversion unit 7, the control display unit 8, the temperature and humidity probe group 9, and the material level indicator 10 form the whole grain total weight detection-based system for on-line measuring and controlling a moisture in circulation drying.

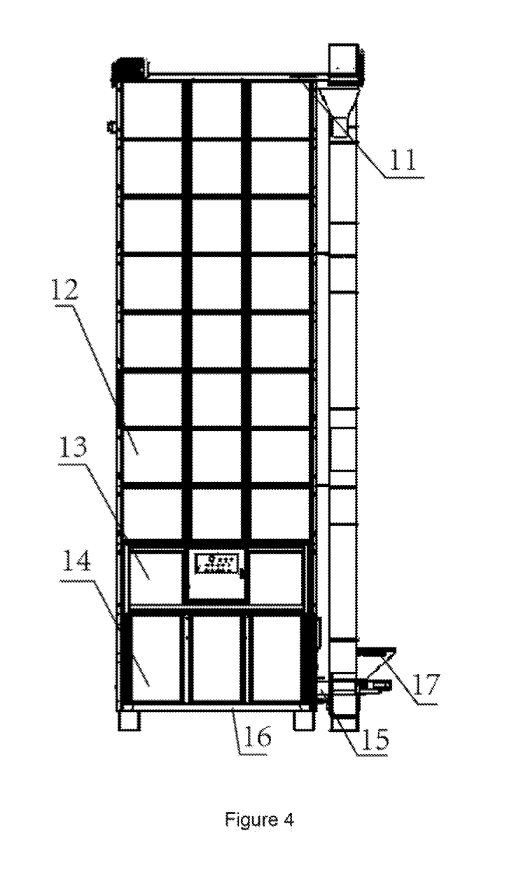

Refer to FIG. 4, the drying machine main body 1 comprises an upper auger 11, a tempering part 12, a drying part 13, a lower body 14 and a loading hopper 17. The upper auger 11 plays a role of conveying grain in the grain feeding/discharge elevator 5 to the tempering part 11. The tempering part 12 is arranged below the upper auger 11, the drying part 13 is arranged below the tempering part 12, and the lower body 14 is arranged below the drying part 13; and the lower body 14 is a main body part of the overall device of the drying machine. The lower body 14 comprises a grain discharge mechanism 15 and a lower auger 16, and plays a role of re-conveying the grain in the lower body 14 into the grain feeding/discharge elevator 5, so as to complete one drying circulation. The grain to be dried re-enters the grain feeding/discharge elevator 5 through the loading hopper 17 after one drying circulation is completed, and enters the next circulation drying process.

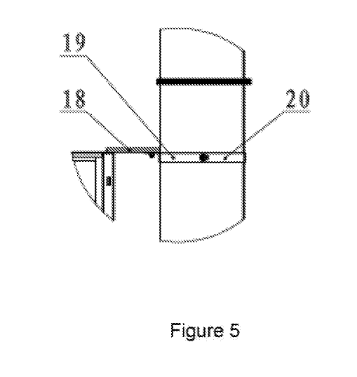

As shown in FIG. 2 and FIG. 5, the part A is in the form of hinge connection, that is, the drying machine main body 1 and the grain feeding/discharge elevator 5 are in the form of hinge connection, so as to avoid the influence of the vibration of the grain feeding/discharge elevator 5 during working on the weighing sensor group 6 below the drying machine main body 1. In the internal structure of the hinge connection, the drying machine main body 1 is fixed together with an inner clamp 19 of the grain feeding/discharge elevator 5 by a connection plate 18 through bolts; the inner clamp 19 is provided with a projected sheet, a plurality of holes are arranged in the sheet, and used for being connected with the connection plate 18 to fix the transversal position of the grain feeding/discharge elevator 5; and the connection plate 18 is connected with the different holes, so that a gap between the drying machine main body 1 and the grain feeding/discharge elevator 5 is adjustable. The inner clamp 19 and an outer clamp 20 are buckled, and connected and fixed on the grain feeding/discharge elevator 5 through bolts; and the longitudinal positions of the inner clamp 19 and the outer clamp 20 along the grain feeding/discharge elevator 5 are adjustable, and used for fixing the different positions of the grain feeding/discharge elevator 5.

As shown in FIG. 2 to FIG. 4, the induced draft fan 3 is connected with the lower body 14 of the drying machine main body 1 in the form of flexible connection, that is, the induced draft fan 3 is connected together with the air exhaust duct 2 through a flexible connector (such as a high-temperature fireproof silicone cloth, a rubber flexible connector, and the like). After this implementation, through the hinge connection of the grain feeding/discharge elevator 5 and the drying machine main body 1, and the connection of the induced draft fan 3 and the drying machine main body 1 through the flexible connector, the influence of the connection and masses of the induced draft fan 3 and the grain feeding/discharge elevator 5 on the detection carried out by the weighing sensor group 6 can be avoided. The combustor 4 is internally installed herein, and may also be replaced by an externally-installed combustor 4, and the drying heat medium must also be connected with the lower body 14 of the drying machine main body 1 through an air tube and a flexible connector during replacement.

As shown in FIG. 2 to FIG. 4, during the working of the drying machine main body 1, the air exhaust duct 2, the induced draft fan 3, the combustor 4, and the grain feeding/discharge elevator 5, the grain in the loading hopper 17 is conveyed to the upper top of the drying machine main body 1 from bottom up through the grain feeding/discharge elevator 5; the conveyed grain is uniformly scattered in the drying machine main body 1 through the upper auger 11; the grain passes downwards through the tempering part 12 and the drying part 13 respectively by virtue of gravity, and arrives at the lower body 14; and the lower body 14 is provided with a six-impeller grain discharge mechanism 15 (a common grain discharge mechanism exists in the prior art), and a grain discharge speed is controlled by the grain discharge mechanism 15. A combustor 4 is installed at one side of the drying machine main body 1, and used for generating the heat medium (preferably, high-temperature air) for drying the grain. The heat medium with an appropriate temperature enters the drying part 13 through the lower body 14 to dry the grain, and the wet heat medium after drying is sucked through the induced draft fan 3 and exhausted via the air exhaust duct 2. The grain is discharged into the lower auger 16 at the inner bottom of the lower body 14 after being dried once; the grain is discharged out of the drying machine main body 1 by the lower auger 16, and enters the grain feeding/discharge elevator 5; and the grain re-enters the drying machine main body 1 through the grain feeding/discharge elevator 5 to be continuously dried, thus a circulation drying process of drying, tempering, drying and tempering is formed. During the circulation drying process, the moisture of the grain is evaporated, so that the weight is reduced, and the measured value of the weighing sensor group 6 of the drying machine is changed due to the change of the weight. The time of the circulation drying or the circulation number of the circulation drying depends on the initial moisture of the grain, the temperature of the heat medium, and the final target moisture.

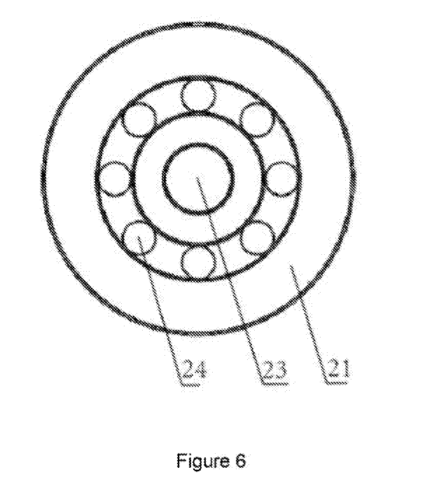

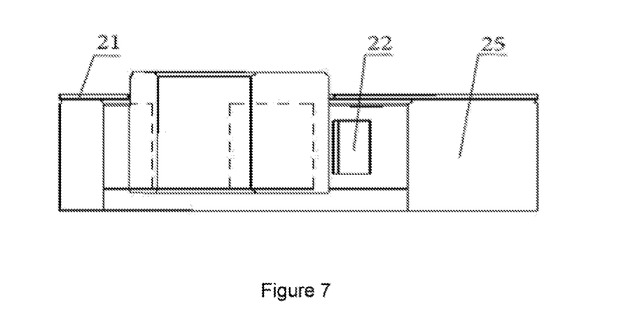

As shown in FIG. 3, FIG. 6 and FIG. 7, the weighing sensor group 6 of the drying machine is composed of a plurality of weighing sensors, and arranged below supporting feet of the lower body 13 of the drying machine main body 1. The weighing sensor group 6 is composed of more than four weighing sensors with the same principle, structure, dimensions, material, range and accuracy. Each weighing sensor comprises an annular isolation pad 21, resistance strain gauges 22, a through hole 23, small through holes 24 and a spoke elastomer 25 herein. Wherein, each annular isolation pad 21 is arranged above the corresponding spoke elastomer 25; and the purpose of adding each annular isolation pad 2 is to prevent dust, rain, snow and other impurities from filling a gap between a detector and the drying machine to influence measurement accuracy and damage the instrument. Each whole sensor is of a spoke-type structure, and the centre part of each weighing sensor is machined into a hub. Each hub part is boss-shaped, and each through hole 23 is axially formed in the centre of the corresponding hub. An annular groove is machined in the outer side of each spoke along a circumferential direction, eight small through holes 24 are uniformly distributed and machined in each annular groove to form eight uniformly-distributed spokes, and the resistance strain gauges 22 are distributed in each small through hole 24, and bonded on the sidewall of the corresponding spoke elastomer 25. A tire is arranged at the outer side of each spoke, and an external load acts on the top of each hub and the bottom of the corresponding tire; and each spoke bears a shear force, and the load is indirectly measured through the force.

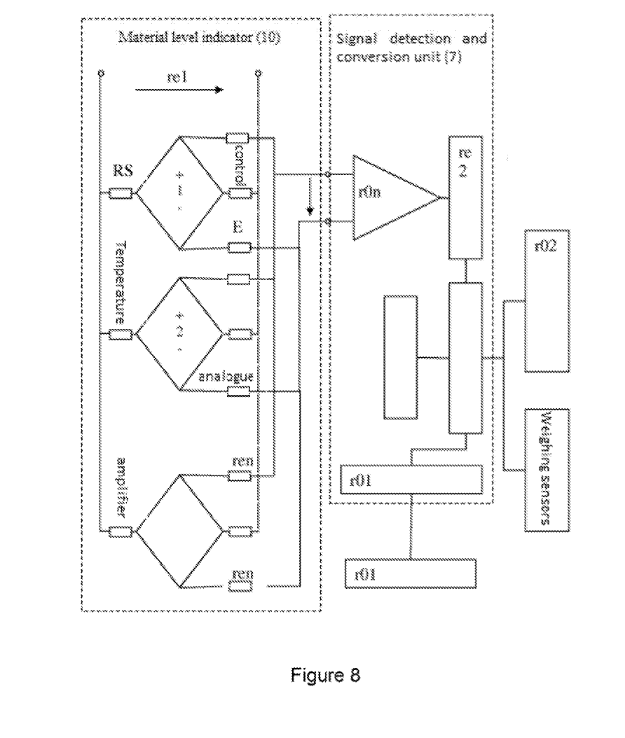

As shown in FIG. 2, FIG. 3, FIG. 7 and FIG. 8, when the weight is changed due to the change of the moisture of the grain in the drying machine main body 1, each spoke elastomer 25 bears a shear force to be deformed; and at this moment, the resistance strain gauges 22 bonded on the spoke elastomer 25 are also deformed, the resistance is changed, and converted to a voltage signal through a bridge circuit, and the voltage signal is transmitted to the signal conversion and detection unit 7.

As shown in FIG. 8, the signal conversion and detection unit 7 is used for collecting and converting the voltage signal. The unit is composed of an amplification and filter circuit, an analogue-digital conversion circuit, a watchdog circuit, an MCU signal processor, and an RS485 serial communication circuit. A JDAI-III moisture detector produced by Changchun Jida Scientific Instrument Equipment Co., Ltd can be adopted in implementation of the signal conversion and detection unit 7.

The circuit is designed that the amplification and filter circuit is primed, so as to eliminate noise and amplify a signal. Then the amplification and filter circuit is connected with the analogue-digital conversion circuit, and takes charge of converting an analogue signal to a digital signal capable of being received by an upper computer. Then an MCU signal processing circuit is connected with the analogue-digital conversion circuit, and takes charge of processing the received digital signal. The watchdog circuit is connected with the MCU circuit, and used for preventing locking, loss and other phenomena of program. Finally, the processed signal is connected with the control and display unit 7 through the RS485 serial communication circuit.

Wherein after the voltage signal passes through the amplification and filter circuit, noise is filtered out, an interference signal is eliminated, and a signal value is amplified. The voltage signal subjected to filter and amplification processing is still an analogue quantity, and cannot be received by the upper computer yet; and at this moment, the signal needs to be converted to a digital signal capable of being received by the upper computer through the analogue-digital conversion circuit. The digital signal is operated through the MCU signal processing circuit. The MCU signal processing circuit is a single chip signal processing circuit. A relationship among the change value of the weight, the voltage signal, the digital signal, and the content of the moisture may be established through operation. In addition, the temperature and humidity probe group 9 is used for transmitting the temperature and humidity signals of the environment, and the temperature and humidity signals in the drying machine main body 1 to the MCU signal processing circuit. An SESTA ST800 temperature and humidity probe group may be used as the temperature and humidity probe group 9. A signal of the material level indicator 10 is connected with the signal conversion and detection unit 7, so as to judge the height of the grain in the drying machine main body 1, and in this way, running of the grain feeding/discharge elevator 5 is controlled. A Shlanyi CX-11 B-type material level indicator may be used as the material level indicator 10.

During running of an MCU system, phenomena such as program run-away, storage failure, external interference and incorrect operation may occasionally occur, thus the system enters an endless loop and cannot normally work. A watchdog circuit needs to be added, and has a basic function of initializing program after software running failure and program disturbance. In this way, the system can be immediately reset in case of such interference, and then the own working stability of a machine is greatly perfected. In this case, the digitized, stable and operated signal is transmitted to the control and display unit 8.

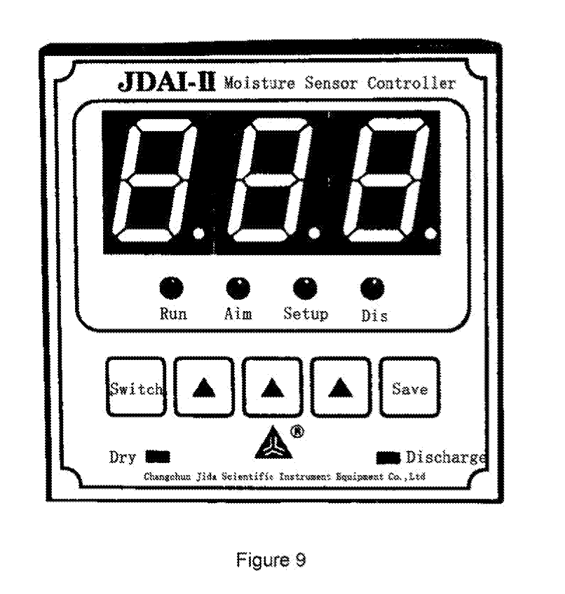

The control and display unit 8 is shown as FIG. 8 and FIG. 9. A JDAI-II moisture sensing control display produced by Changchun Jida Scientific Instrument Equipment Co., Ltd can be used as the control and display unit 8.

The control and display unit 8 enters a manual mode or an automatic mode through a ‘setup’ key to control the combustor 4 and the grain discharge mechanism 15, and the type of the grain, such as corn and rice, is selected through a ‘type’ key. An expected moisture value is set through a ‘save’ key. The signal subjected to operation processing is transmitted to the control and display unit 8. The real-time moisture value is displayed on a panel, and thus detection and control for the moisture are realized, so that the grain achieves a target value of the moisture.

In summary, realization of the circulation measurement and control method based on detection for the moisture in the total weight of the grain is completed through operation and control for the circulation measurement and control system based on detection for the moisture in the total weight of the grain.

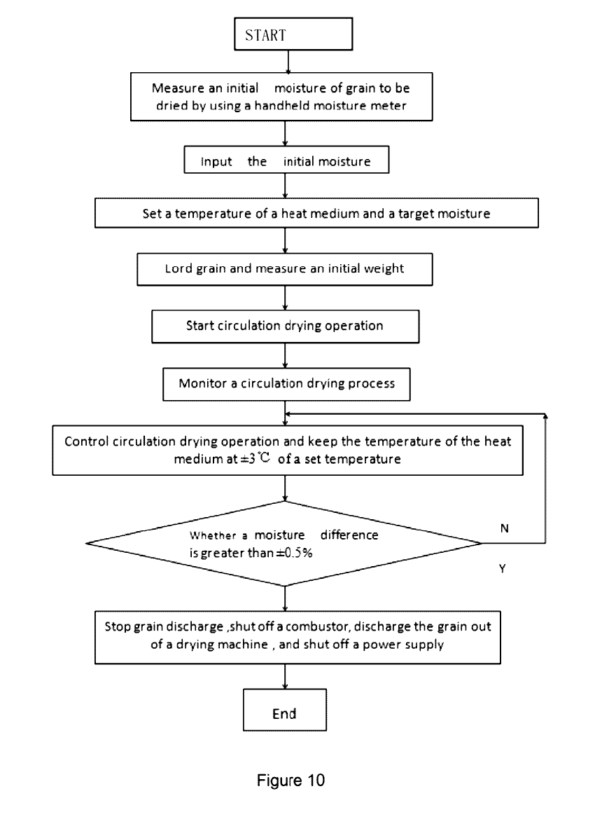

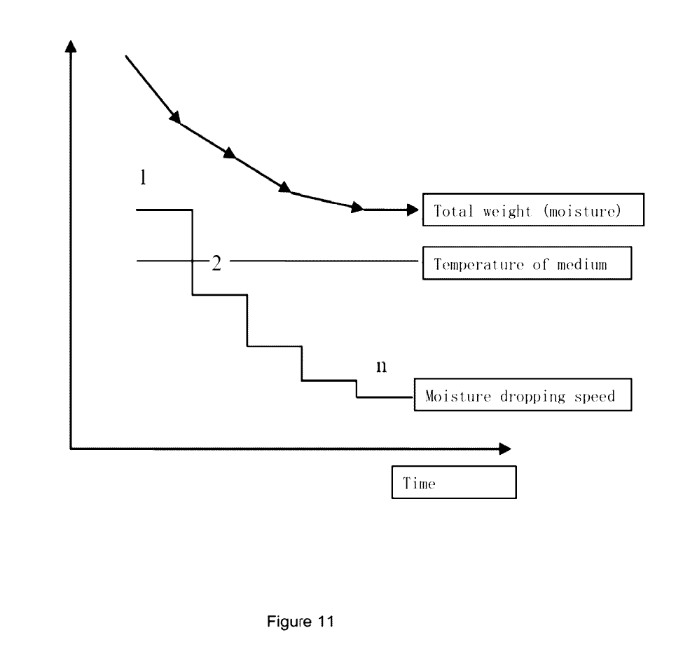

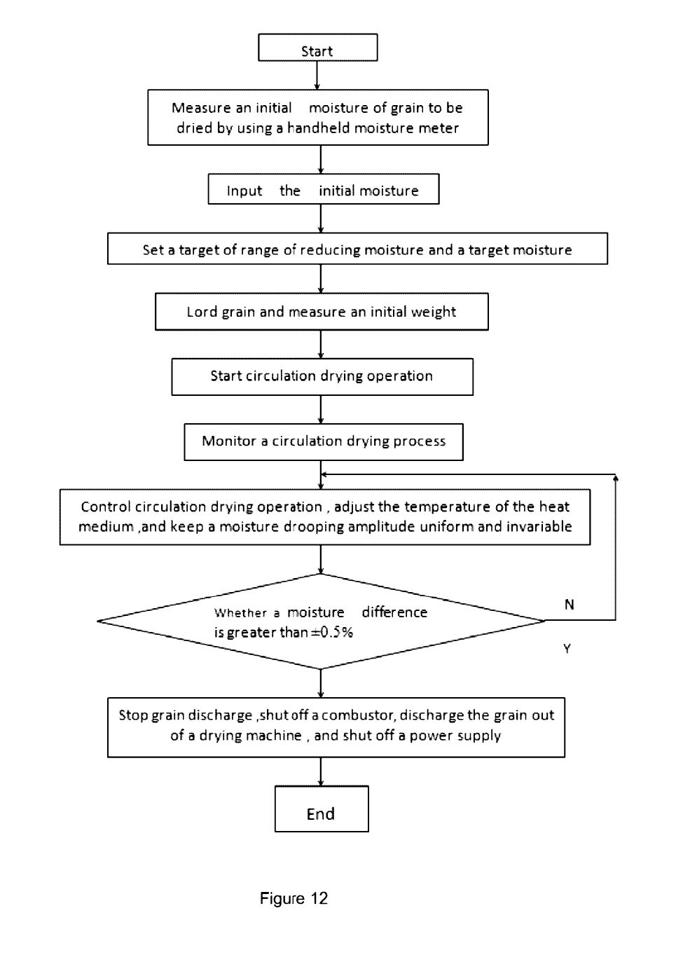

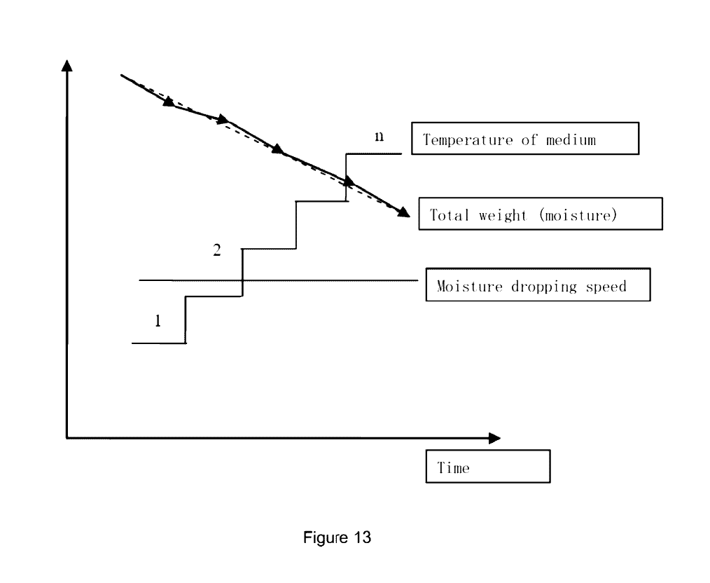

As shown in FIG. 10, FIG. 11, FIG. 12 and FIG. 13, the method for on-line measuring and controlling the moisture in the grain drying machine, of the present invention, has two modes of constant-temperature drying and speed-limiting drying, for enabling the grain to achieve the target value of the moisture.

Mode I: constant-temperature control (constant-medium control). A process of constant-temperature control for circulation drying of grain is shown in FIG. 10 and FIG. 11. In the circulation drying operation, the temperature of the heat medium is set and controlled to be unchanged. In the initial stage of drying, the moisture content of the grain is high, the moisture diffusion speed is fast, the moisture dropping speed is also fast, and the temperature of the grain is remarkably lower than the temperature of the medium. With the progress of the drying process, the moisture dropping of the grain is gradually slowed down, the total weight dropping of the grain is also slowed down, and the temperature of the grain is gradually increased to be close to the temperature of the medium. During the process, the control and display unit automatically compares a set target moisture (total weight) with an actually-measured moisture (total weight), and after the difference is less than 0.5% of the moisture, the circulation drying machine is controlled to stop drying.

Mode II: constant-speed control (constant-moisture dropping speed control). A process of constant-speed variable-temperature control for circulation drying of grain is shown in FIG. 12 and FIG. 13. In order to overcome quality declining of the grain due to that the moisture dropping speed is fast initially and is flow later, existing in the process of constant-temperature drying, the present invention provides the constant-speed variable-temperature control, that is, the quantity of moisture dropping of the grain in a unit time is enabled to be the same, or the mass reduction of the total weight (containing the grain) of the drying machine in a unit time is enabled to be the same by continuously adjusting the temperature of the medium. Likewise, during the process, the control and display unit automatically compares a set target moisture (total weight) with an actually-measured moisture (total weight), and after the difference is less than 0.5% of the moisture, the circulation drying machine is controlled to stop drying.

The constant-speed control belongs to switch quantity control, logical judgment and model predictive analysis are carried out on the basis of the total weight or the moisture of the grain, the temperature of the grain, the temperature and humidity of the heat medium, and the temperature and humidity of environment, and the temperature of the heat medium, and a grain discharge speed are controlled, so that the moisture dropping speed of the grain is kept at or lower than a certain value (for example, the moisture dropping speed of rice is kept at 0.8%, and the moisture dropping speed of corn is lower than 2.5%) until the safe moisture is achieved. A classical PID method or a predictive control method (combining model prediction for a moisture change with PID control) is adopted in control strategies of the constant-speed control and the speed-limiting control.

### The Second Embodiment

The various weight parameters measured by the weighing sensor group 6 of the drying machine are essential for a drying effect, and the quality of the connection manner of the weighing sensor group 6 of the drying machine, and the drying machine directly influences a measurement result.

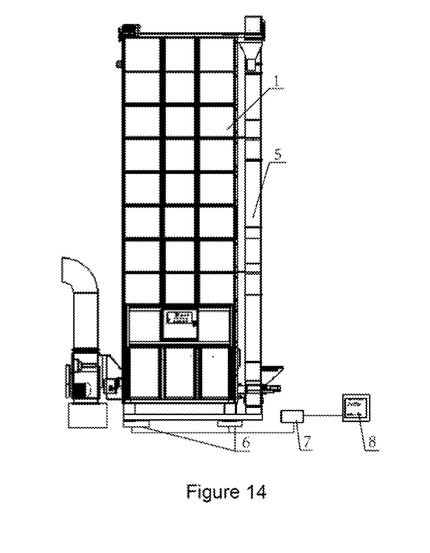

Refer to FIG. 14, in the embodiment, the total weight detection-based system for on-line measuring and controlling the moisture in circulation drying of grain, of the present invention, is a change on the basis of the first embodiment, the similarities will not be repeated, except that, the drying machine main body 1 and the grain feeding/discharge elevator 5 are connected with the weighing sensor group 6 of the drying machine in a fully-supporting manner; and the fully-supporting manner is that the drying machine main body 1, the grain feeding/discharge elevator 5 and the like are installed above the connection bottom plate 26, and the weighing sensor group 6 of the drying machine is installed below the connection bottom plate 26.

### The Third Embodiment

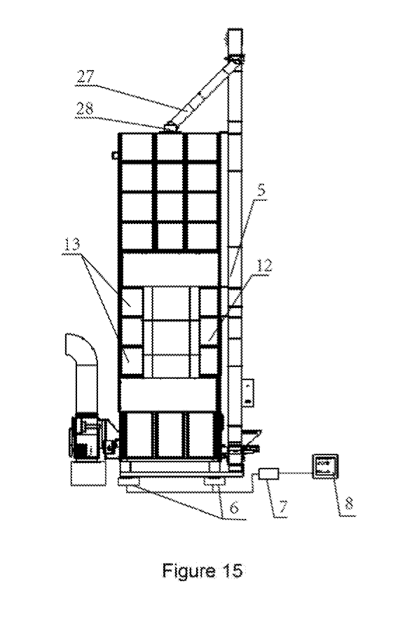

Refer to FIG. 15, the total weight detection-based system for on-line measuring and controlling the moisture in circulation drying of grain, of the present invention, is a change on the basis of the first embodiment, the similarities will not be repeated, except that, the drying part 13 adopts a double-drying-part mode, and one drying part 13 is changed into two drying parts 13. The upper auger 11 is cancelled, and a grain feeding slide tube 27 and a buffer 28 are added; and the grain in the grain feeding/discharge elevator 5 enters the tempering part 12 through the grain feeding slide tube 27 and the buffer 28.

### The Fourth Embodiment

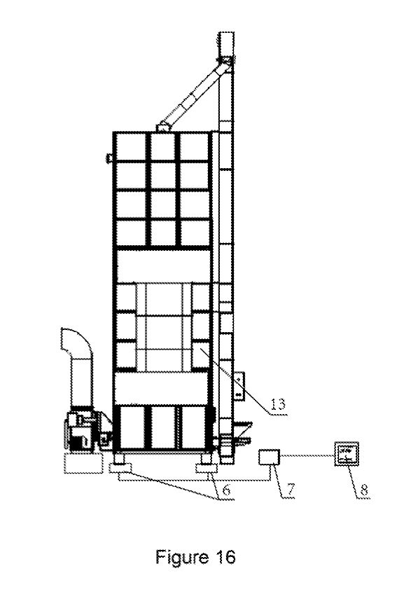

Refer to FIG. 16, the total weight detection-based system for on-line measuring and controlling the moisture in circulation drying of grain, of the present invention, is a change on the basis of the first embodiment, the similarities will not be repeated, except that, a semi-supporting connection manner is adopted. The connection bottom plate 26 is cancelled, and weighing sensor group 6 for the total weight of the drying machine (containing the grain) is installed below supporting feet of the lower body 14. A semi-supporting structure is as follows: the weighing sensor group is installed under supporting feet of the base of the drying machine, the weight of the drying machine main body containing the grain falls onto the sensors, the grain feeding/discharge elevator is connected with the drying machine main body in a hinge manner, and a hot-blast stove and the induced draft fan are connected with the drying machine main body through air tube flexible connectors; in this way, influence of the connections, vibrations and masses of the elevator, the hot-blast stove and the induced draft fan on the detection carried out by the weighing sensors is avoided.

The above-mentioned description for the embodiments is merely used for facilitating those of ordinary skill in the art to understand and apply the present invention. Obviously, the person skilled in the art can easily make various modifications on these embodiments, and apply general principles illustrated herein to other embodiments without any creative effort. Therefore, the present invention is not limited to the embodiments herein, and the improvements and modifications made by the person skilled in the art according to the disclosure of the present invention and without departing from the scope of the present invention should all be within the protection scope of the present invention.

### INDUSTRIAL APPLICABILITY

According to the present invention, the change of the moisture of the grain during the drying process is detected through the detection for the total weight of the drying machine and the grain in the drying machine, and on-line control for the moisture of the grain is realized; and industrial applicability with good effect is achieved.

We claim:

1. A weight detection-based method for measuring and controlling a moisture in grain drying, characterized in that:
step 1, conveying grain to be dried into a grain circulation drying machine, and starting drying operation;
step 2, calculating an average moisture value Mᵢ at time i of the grain to be dried in real time:
$${M}_{i} = \frac{( {W}_{0} - {W}_{b} ) {M}_{0} - ( {W}_{0} - {W}_{i} )}{{W}_{i} - {W}_{b}}$$
wherein, W₀ is the initial total weight of the grain to be dried and loaded in the drying machine, W_{b} is the tare weight, Wᵢ is the total weight at time i during the drying process, and M₀ is the initial moisture; and
step 3, when the moisture value Mᵢ of the grain has not yet entered the fluctuation value range of the target moisture value, conveying the grain to the top of the circulation drying machine from the bottom of the circulation drying machine for re-circulation, and returning to the step 2; and when the moisture value Mᵢ of the grain enters the fluctuation value range of the target moisture value, stopping supply of the heat medium, and then completely discharging the grain in the drying machine.

2. The method for measuring and controlling according to claim 1, wherein in the step 2, a moisture dropping speed V is further calculated:
$$V = \frac{Δ M}{Δ t}$$
wherein, ΔM is the difference between the moisture values obtained through calculations with a certain time interval, and Δl is the time interval length.

3. The method for measuring and controlling according to claim 2, wherein in the step 1, two working modes may also be set, one is a constant-temperature mode for keeping the temperature of the provided heat medium at a set temperature; and the other one is a speed-limiting mode for adjusting the temperature of the heat medium to control a real-time moisture dropping speed to be less than a set value.

4. The method for measuring and controlling according to claim 1, wherein when the grain to be dried is conveyed into the drying machine, the height of the grain is controlled, and the conveying is continued if a set height is not achieved; and the conveying is stopped after the set height is achieved.

5. The method for measuring and controlling according to claim 1, wherein before the drying operation is started, the weighing sensor group detects the initial total weight W₀ and the tare weight W_{b}; and during the running process of the drying operation, the weighing sensor group detects the total weight Wᵢ in real time.

6. An automatic operation system for circulation drying of grain, comprising a drying machine main body (1), an induced draft fan (3) and a grain feeding/discharge elevator (5). The automatic operation system for circulation drying of grain is characterized by further comprising a weighing sensor group (6), wherein the weighing sensor group (6) is arranged below the drying machine main body (1); and the weighing sensor group is used for detecting an initial total weight of the drying machine loaded with the grain to be dried, a tare weight, and a real-time total weight of the grain.

7. The automatic operation system according to claim 6, wherein the drying machine main body (1) is hinged with the grain feeding/discharge elevator (5); and the drying machine main body (1) is connected with the induced draft fan (3) through a flexible connector.

8. The automatic operation system according to claim 6, wherein the drying machine main body (1) and the grain feeding/discharge elevator (5) are arranged above a connection bottom plate (26), and the weighing sensor group (6) is arranged below the connection bottom plate (26).

9. The automatic operation system according to claim 6, further comprising a grain feeding slide tube (27) and a buffer (28), wherein the grain in the grain feeding/discharge elevator (5) enters a tempering part (12) through the grain feeding slide tube (27) and the buffer (28), and two separated drying parts (13) are arranged below the tempering part (12).

10. The automatic operation system according to claim 6, wherein the weighing sensor group (6) is arranged below supporting feet of the base of the drying machine main body; and the weighing sensor group (6) is composed of a plurality of sensors which are uniformly distributed and arranged.
